(19) United States
(12) Patent Application Publication
(10) Pub. No.: US 2014/0076367 A1
(43) Pub. Date: Mar. 20, 2014

(54) VAPOR CLEANING APPARATUS FOR A RANGE HOOD

(71) Applicant: Hsiao-Ping HUNG, Taichung City (TW)

(72) Inventor: Hsiao-Ping HUNG, Taichung City (TW)

(21) Appl. No.: 13/616,188

(22) Filed: Sep. 14, 2012

(51) Int. Cl. B08B 3/00

(52) U.S. Cl. 134/105

(57) ABSTRACT

A range hood vapor cleaning apparatus has a vapor cleaning module, a control module, an input module and a fan driver module. The control module is electrically connected to the vapor cleaning module, the input module and the fan driver module. The control module is controlled by the input module and executes a vapor cleaning mode. When the control module executes the vapor cleaning mode, the control module controls the vapor cleaning module to generate vapor and meanwhile activates the fan driver module to drive a fan motor to blow the vapor to a fan housing and an exhaust fan and to exhaust the vapor out of the fan housing.

### BACKGROUND OF THE INVENTION

1. Field of the Invention

The present invention relates to a range hood cleaning apparatus, and more particularly to a vapor cleaning apparatus for a range hood.

2. Description of Related Art

Basically, a range hood has a fan housing and at least one exhaust fan mounted in the fan housing. When the range hood operates, the exhaust fan exhausts cooking fume outdoors rather than throughout the kitchen. However, the cooking fume easily adheres to the exhaust fan and the interior surface of the fan housing to build up dirty grease. The exhaust fan and the fan housing then become greasy. The user has to disassemble the range hood to clean the exhaust fan and the fan housing after several times of using the range hood. After cleaning the exhaust fan and the fan housing, the user needs to assemble the range hood again. That is really inconvenient for the user.

Presently, an electrical heater can solve the problem mentioned above. The electrical heater is mounted on the exterior surface of the fan housing. When the electrical heater operates, the electrical heater heats the fan housing to melt the dirty grease adhering to the fan housing. The dirty grease is then stripped from the fan housing.

Because the electrical heater is mounted on the exterior surface of the fan housing, the electrical heater only strips off the dirty grease on the fan housing but is unable to strip off the dirty grease on the exhaust fan. Moreover, the electrical heater consumes much electric power to heat the whole fan housing and causes high cost for cleaning the range hood.

### SUMMARY OF THE INVENTION

An objective of the present invention is to provide a vapor cleaning apparatus for a range hood. The apparatus mainly generates high temperature vapor to melt the dirty grease on both the exhaust fan and the fan housing.

The vapor cleaning apparatus of the invention comprises an input module, a vapor cleaning module, a fan driver module and a control module.

The input module has multiple buttons.

The vapor cleaning module has a heater and a water dispenser. The water dispenser pours water to the heater.

The fan driver module is electrically connected to a fan motor.

The control module is electrically connected to the input module, the vapor cleaning module and the fan driver module, is controlled by the input module and executes a vapor cleaning mode. When the control module executes the vapor cleaning mode, the control module controls the heater to heat the water into vapor and activates the fan driver module to drive a fan motor to blow the vapor to a fan housing and an exhaust fan and to exhaust the vapor out of the fan housing.

The vapor generated from the heater is blown into the fan housing. Hence, the vapor can melt the dirty grease adhering to the fan housing and the exhaust fan which is mounted in the fan housing. Finally, the vapor with melted grease is exhausted out of the fan housing.

Comparing with the conventional electrical heater, the vapor cleaning apparatus of the present invention cleans both the fan housing and the exhaust fan. The cleaning effect of the present invention is better than the conventional electrical heater. In addition, the power consumption is lower than the electrical heater because the apparatus of the present invention only heats the water instead of heating the whole fan housing.

### BRIEF DESCRIPTION OF THE DRAWINGS

FIG. 1 is a circuit block diagram of the vapor cleaning apparatus of the present invention;

FIGS. 2A-2E are detailed circuit diagrams of the vapor cleaning apparatus of the present invention; and

FIG. 3 is a bottom view of a range hood with the vapor cleaning apparatus of the present invention.

### DETAILED DESCRIPTION OF THE PREFERRED EMBODIMENT

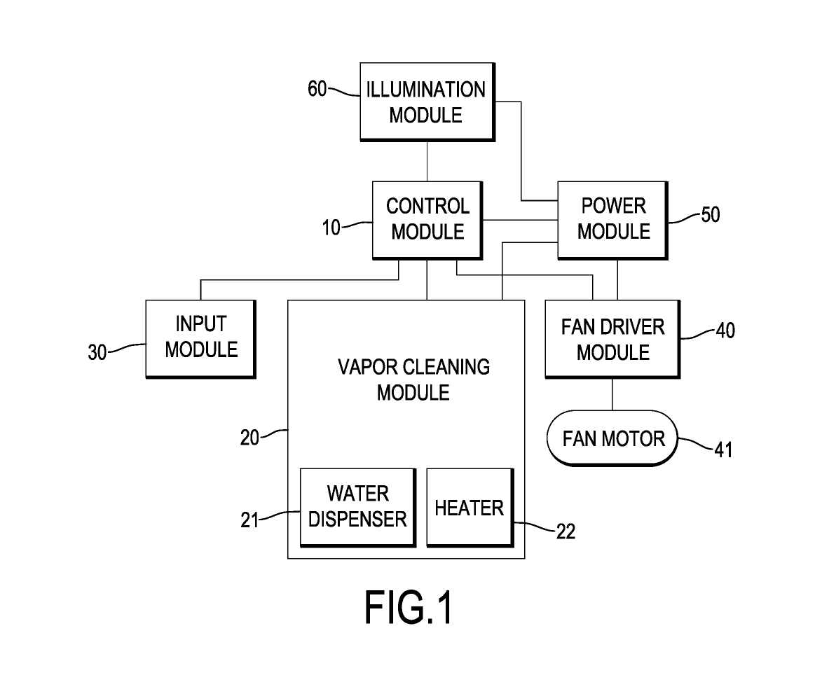

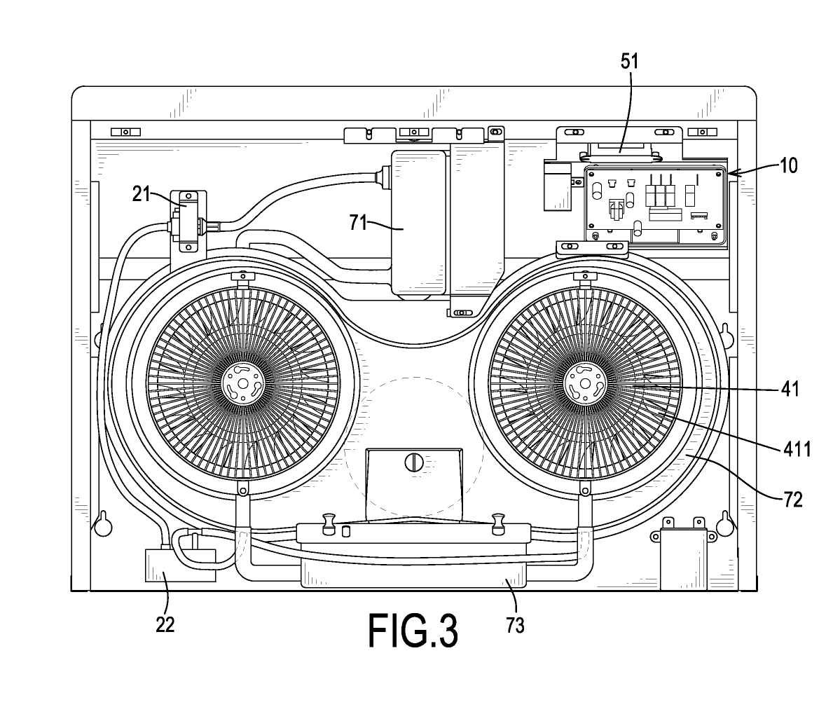

With reference to FIGS. 1 and 3, a vapor cleaning apparatus of the present invention comprises a control module 10, a vapor cleaning module 20, an input module 30, a fan driver module 40, a power module 50 and an illumination module 60. The vapor cleaning apparatus of the present invention is installed in a range hood. The fan driver module 40 connects to a fan motor 41. The fan motor connects to an exhaust fan 411. The fan motor 41 and the exhaust fan 411 are mounted in a fan housing 72.

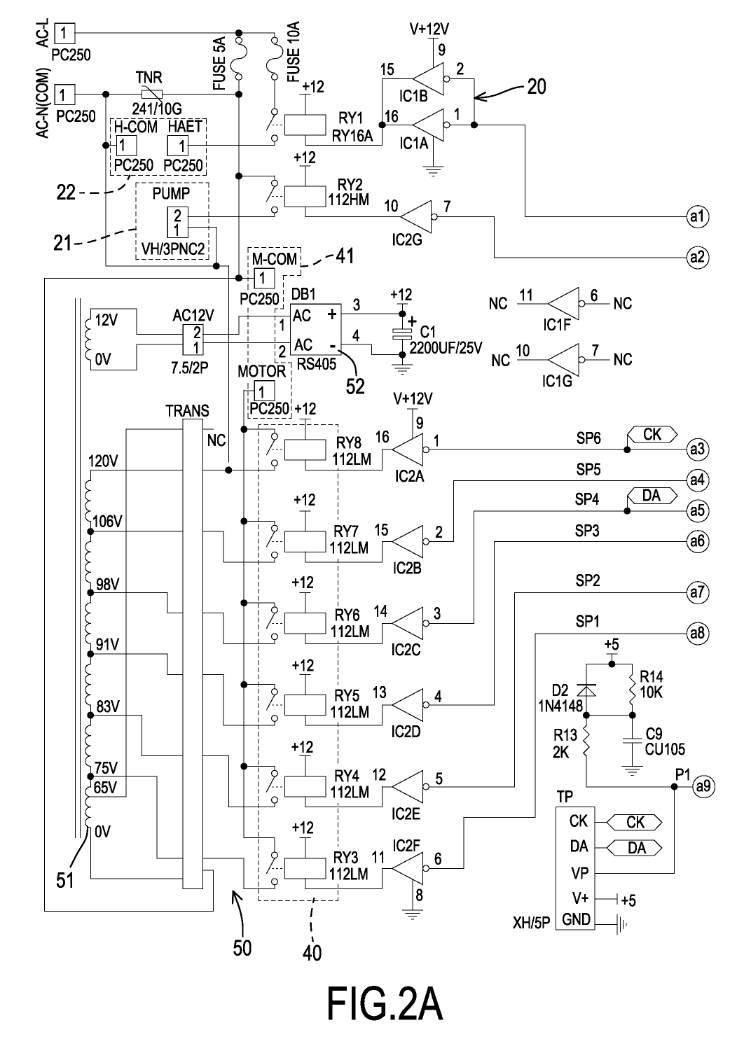

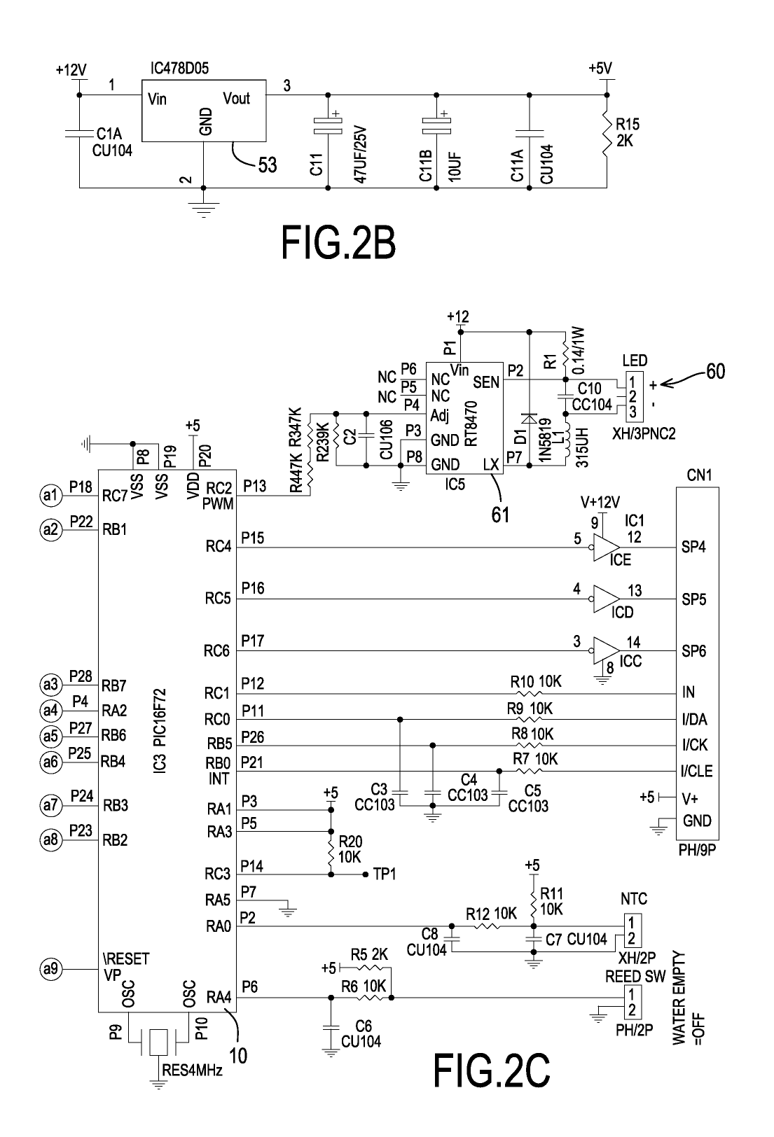

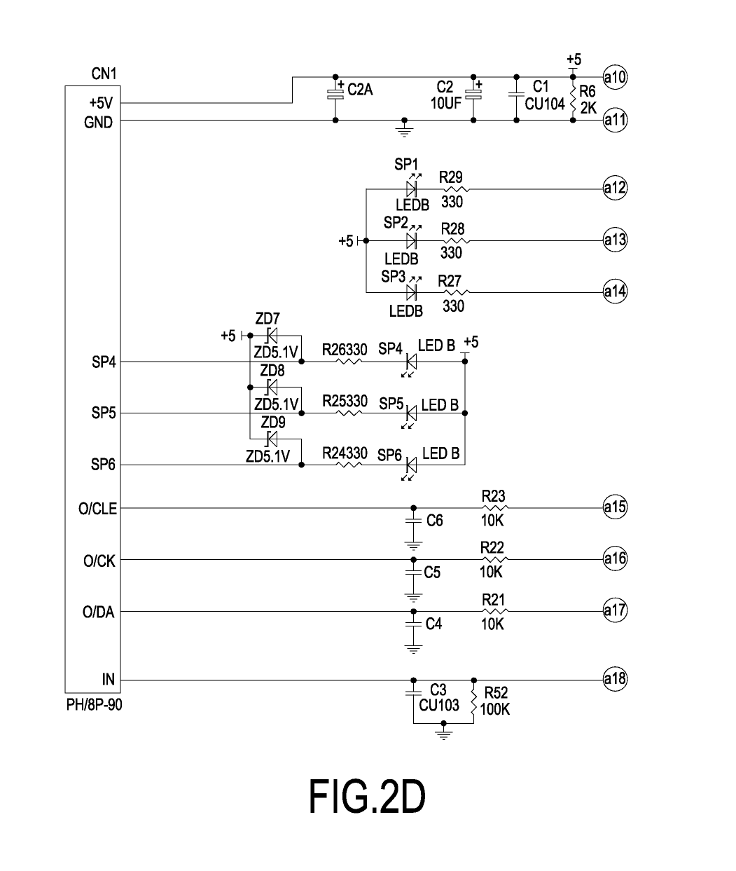

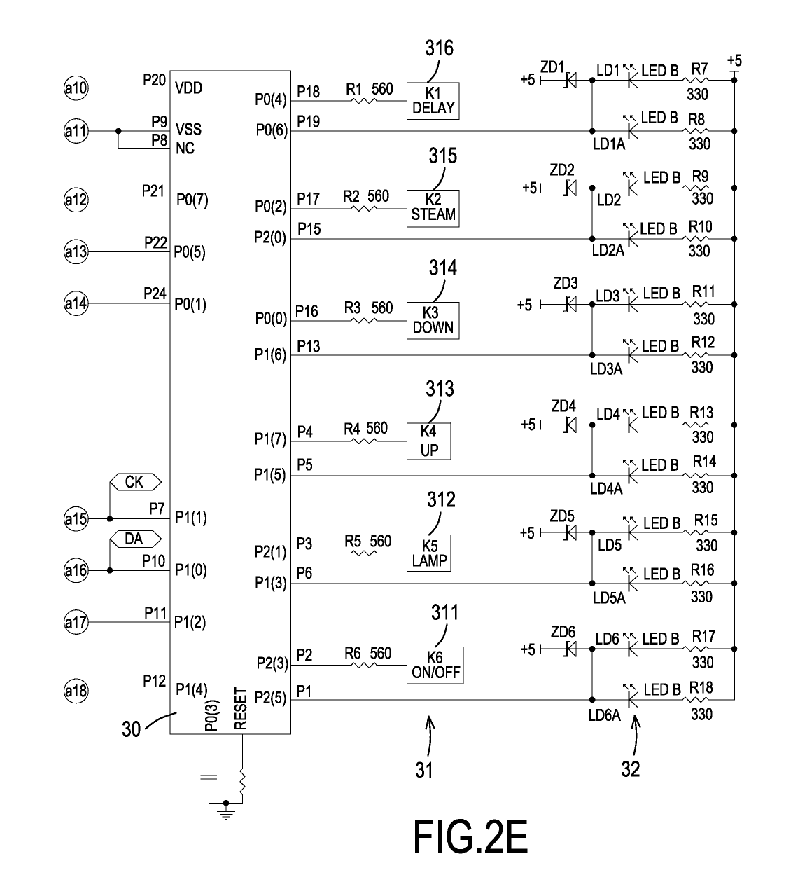

The power module 50 supplies AC or DC working voltages to the control module 10, the vapor cleaning module 20, the input module 30, the fan driver module 40 and the illumination module 60. With reference to FIGS. 1 and 2A-2E, the power module 50 has a transformer 51, a rectifier regulator 52 and a regulator 53.

The transformer 51 has a power input terminal and multiple power output terminals. The power input terminal is electrically connected to an external AC power. The power output terminals respectively output voltage potentials including AC-12V, AC-75V, AC-83V, AC-91V, AC-98V, AC-106V and AC-120V.

The rectifier regulator 52 is electrically connected to the power output terminal of AC-12V and converts the AC-12V into DC-12V.

The regulator 53 is electrically connected to the rectifier regulator 52 and the control module 10 to convert the DC-12V to DC-5V for supplying the control module 10.

The fan driver module 40 is electrically connected to the power output terminals of the transformer 51. The fan driver module 40 adjusts the rotational speed of the fan motor 41 according to the voltage potential received from the power output terminal of the transformer 51. The rotational speed of the fan motor 41 is directly proportional to the voltage potential received from the transformer 51. For example, the fan driver module 40 adjusts the rotational speed of the fan motor 41 among six speed options, i.e., a first speed, a second speed, a third speed, a fourth speed, a fifth speed, and a sixth speed, wherein the sixth speed is the fastest and the first speed is the slowest. In this embodiment, the voltages AC-75V, AC-83V, AC-91V, AC-98V, AC-106V and AC-120V respectively correspond to the first speed, the second speed, the third speed, the fourth speed, the fifth speed, and the sixth speed.

The vapor cleaning module 20 has a water dispenser 21 and a heater 22. The water dispenser 21 pours water into the heater 22 from a water tank 71 through a pipe. The heater 22 is used to heat the water.

The control module 10 is electrically connected to the fan driver module 40 and the vapor cleaning module 20. The control module 10 executes a vapor cleaning mode and a hot water cleaning mode.

When the control module 10 executes the vapor cleaning mode, the control module 10 controls the heater 22 to heat the water into vapor. Meanwhile, the control module 10 activates the fan driver module 40 to drive the exhaust fan 411 to blow the vapor into the fan housing 72. The vapor then melts dirty grease adhering to the exhaust fan 411 and the fan housing 72. The exhaust fan 411 also exhausts the vapor with melted grease out of the fan housing 72.

With reference to FIG. 3, when the control module 10 finishes executing the vapor cleaning mode, the control module 10 executes the hot water cleaning mode. When the control module 10 executes the hot water cleaning mode, the control module 10 controls the heater 22 to heat the water. The heated hot water is directly drawn toward the fan housing 72 and the exhaust fan 411 by a pump. The hot water rinses the melted grease away from the fan housing 72 and finally flows into an oil container 73 with the melted grease.

The input module 30 can be a touch panel or a real button panel. The input module 30 is electrically connected to the control module 10 and has multiple buttons 31. Each button 31 comprises a back light unit 32. The control module 10 is controlled by the input module 30. The buttons 31 include a power button 311, an illumination button 312, a speed up button 313, a speed down button 314, a vapor cleaning button 315 and a delay button 316.

The illumination module 60 has an LED controller 61 and at least one LED. The controller 61 is electrically connected to the control module 10. The at least one LED is electrically connected to the controller 61.

The power button 311 is used to control the control module 10 to turn on or turn off the power module 50. The illumination button 312 is used to control the control module 10 to change illumination modes of the illumination module 60. The illumination modes include a full brightness mode, a slight brightness mode and a darkness mode. The speed up button 313 is used to control the control module 10 to increase the rotational speed of the fan motor 41. The speed down button 314 is used to control the control module 10 to decrease the rotational speed of the fan motor 41. The vapor cleaning button 315 is used to control the control module 10 to execute the vapor cleaning mode. The delay button 316 is used to control the control module 10 to turn off the power module 50 after a delay time. A default delay time can be five minutes.

In conclusion, the vapor cleaning module 20 is controlled to generate vapor by the control module 10. The dirty grease adhering to both the exhaust fan 411 and the fan housing 72 are melted by the vapor and is rinsed away by hot water. Hence, the cleaning effect in the fan housing 72 is improved.

What is claimed is:

1. A vapor cleaning apparatus for a range hood having a fan housing and an exhaust fan, the vapor cleaning apparatus comprising:
an input module having multiple buttons;
a vapor cleaning module having:
a heater; and
a water dispenser pouring water to the heater;
a fan driver module electrically connected to a fan motor; and
a control module electrically connected to the input module, the vapor cleaning module and the fan driver module, controlled by the input module and executing a vapor cleaning mode; wherein when the control module executes the vapor cleaning mode, the control module controls the heater to heat the water into vapor and activates the fan driver module to drive the fan motor to blow the vapor to the fan housing and the exhaust fan of the range hood and to exhaust the vapor out of the fan housing.

2. The apparatus as claimed in claim 1 comprising a power module, wherein the power module has:
a rectifier regulator electrically connected to the control module; and
a transformer having multiple power output terminals; one of the power output terminals electrically connected to the rectifier and the other power output terminals electrically connected to the fan driver module.

3. The apparatus as claimed in claim 2, wherein each button comprises a back light unit.

4. The apparatus as claimed in claim 3, wherein the control module activates the fan driver module to switch among six rotational speeds for the fan motor.

5. The apparatus as claimed in claim 1, wherein the buttons of the input module include a power button, an illumination button, a speed up button, a speed down button, a vapor cleaning button and a delay button.

6. The apparatus as claimed in claim 2, wherein the buttons of the input module include a power button, an illumination button, a speed up button, a speed down button, a vapor cleaning button and a delay button.

7. The apparatus as claimed in claim 3, wherein the buttons of the input module include a power button, an illumination button, a speed up button, a speed down button, a vapor cleaning button and a delay button.

8. The apparatus as claimed in claim 4, wherein the buttons of the input module include a power button, an illumination button, a speed up button, a speed down button, a vapor cleaning button and a delay button.

9. The apparatus as claimed in claim 5, wherein the delay button is used to control the control module to turn off the power module after a delay time.

10. The apparatus as claimed in claim 6, wherein the delay button is used to control the control module to turn off the power module after a delay time.

11. The apparatus as claimed in claim 7, wherein the delay button is used to control the control module to turn off the power module after a delay time.

12. The apparatus as claimed in claim 8, wherein the delay button is used to control the control module to turn off the power module after a delay time.

13. The apparatus as claimed in claim 1, wherein the illumination module operates in multiple modes including a full brightness mode, a slight brightness mode and a darkness mode.

14. The apparatus as claimed in claim 2, wherein the illumination module operates in multiple modes including a full brightness mode, a slight brightness mode and a darkness mode.

15. The apparatus as claimed in claim 3, wherein the illumination module operates in multiple modes including a full brightness mode, a slight brightness mode and a darkness mode.

16. The apparatus as claimed in claim 4, wherein the illumination module operates in multiple modes including a full brightness mode, a slight brightness mode and a darkness mode.
